(19) United States
(12) Patent Application Publication
(10) Pub. No.: US 2015/0303677 A1
(43) Pub. Date: Oct. 22, 2015

(54) ELECTRIC POWER GENERATION SYSTEM USING PERMANENT MAGNET MACHINE WITH IMPROVED FAULT REMEDIATION

(71) Applicant: HONEYWELL INTERNATIONAL INC., MORRISTOWN, NJ (US)

(72) Inventors: Mohamed A. Salam, Torrance, CA (US); Evgeni Ganev, Torrance, CA (US); William Warr, Glendale, CA (US)

(73) Assignee: HONEYWELL INTERNATIONAL INC., MORRISTOWN, NJ (US)

(21) Appl. No.: 14/254,663

(22) Filed: Apr. 16, 2014

(51) Int. Cl. H02H 3/20

(52) U.S. Cl. CPC H02H 3/202

(57) ABSTRACT

A system for generating and supplying electrical power to DC loads on an aircraft may include a permanent magnet machine (PMM) generating an output voltage at a plurality of output terminals and a solid-state switch connected to each of the output terminals to short-circuit the output terminal when the switch is ON. A control unit may be configured to detect an unbalanced fault in the system and, responsively to said detection, to close all of the switches simultaneously to convert the unbalanced fault to a balanced fault so that DC currents are precluded from circulating within the PMM.

### BACKGROUND OF THE INVENTION

The present invention generally relates to high speed generators and, more specifically, to apparatus and methods for improved fault remediation in a permanent magnet machine based electrical power generation system.

Electrical power generation systems (PGS) play a significant role in the modern aerospace/military industry. This is particularly true in the area of more electric architecture (MEA) for aircraft and spacecraft. The commercial aircraft business is moving toward no-bleed air environmental control systems (ECS), variable-frequency (VF) power distribution systems, and electrical actuation.

These new aerospace trends have significantly increased power generation needs. This has led to increased operating voltages to reduce system losses, weight, and volume. New power quality and electromagnetic interference (EMI) requirements have been created to satisfy both quality and performance needs. Therefore, overall system performance improvement and power density increases are necessary for the new-generation hardware to satisfy MEA. Decreasing the cost of power generation systems will help make the new platforms more affordable.

DC bus short-circuit protection to reduce damages that may lead to a hazardous condition must be provided when an external short-circuit fault occurs at the DC distribution bus. Feeder short-circuit protection function is required to prevent excessive current flow in electric machines and interface electric machine power electronics. Power electronics short-circuit protection is required to prevent excessive current flow in the power electronics unit.

Electric machines used in auxiliary power unit (APU) applications typically operate at constant speed or with small speed variation. However, the main engines of an airplane normally operate with a speed range where the ratio of maximum to minimum operating speed is about 2 to 1. This speed variation creates difficulties for a power generation system in providing regulated power within the entire speed range. There are some applications where the speed of the prime mover, for instance a helicopter engine, changes by a factor of up to 20.

Synchronous permanent magnet machines (PMM) present a very competitive design that outperforms other electric machines in most applications when weight and size are critical. However, the rotor flux in a typical PMM is fixed and cannot be controlled or disengaged. Unlike other machines where the excitation of the rotor flux can be controlled and even disabled quickly, a PMM continues to generate emf until the rotor stops rotating. Therefore, the PMM presents a hazard in generator applications, leading to its limited use, particularly in the aerospace industry.

In the same way that aircraft system's design is becoming more electric, aircraft engine controls are becoming more electric. Many of the hydraulic and fueldraulic engine controls and actuators are being converted to electro-mechanical systems. In addition, electric machines are getting directly coupled to the engine shaft. These trends expose the electric machine and the power electronics used for power conditioning and controls to high temperatures. Engine controllers can be exposed to ambient temperature from 80° C. to 120° C. while the machines are exposed to a much higher temperature range.

A harsh engine environment inherently makes engine embedded power generation system very difficult to design. Not only is the system required to have high power density but also to be very reliable in this harsh environment. Prior art systems which utilize conventional PM or wound-field generators have limitations. One of the limitations of the conventional PMG is short-circuit current capability. Conventional PMG short circuit current can be 5× or more of rated current. Wound-field generators do not have short circuit current problems as the field is externally controlled. However, rotating rectifiers inside the wound-field machine may not survive an engine embedded high temperature environment.

As can be seen, there is a need for a power generation systems that can supply power to a DC bus within a wide speed variation while providing the short-circuit fault protection discussed above. Furthermore, it can be seen that there is a need for such a system that can tolerate operation at high temperatures in an engine-embedded environment.

### SUMMARY OF THE INVENTION

In one aspect of the present invention, a system for generating and supplying electrical power to DC loads may comprise: a permanent magnet machine (PMM) generating an output voltage at a plurality of output terminals; a solid-state switch connected to each of the output terminals to short-circuit the output terminal when the switch is ON; and a control unit configured to detect an unbalanced fault in the system and, responsively to said detection, to close all of the switches simultaneously to convert the unbalanced fault to a balanced fault so that DC currents are precluded from circulating within the PMM.

In another aspect of the present invention, apparatus for fault remediation in a permanent magnet generator system may comprise at least one bridge circuit connected to a plurality of output terminals of a permanent magnet machine (PMM), the bridge circuit including a plurality of solid-state switches, each connected to one of the output terminals, and actuatable to simultaneously short-circuit all of the output terminals upon detection of an unbalanced fault in the system so that the unbalanced fault is converted to a balanced fault and so that DC currents are precluded from circulating within the PMM.

In still another aspect of the present invention, a method for fault remediation in a permanent magnet generator system may comprise the steps: producing multiphase AC power with a permanent magnet machine (PMM) at a plurality of phase winding output terminals of the PMM; detecting an unbalanced fault in the system; and simultaneously producing short circuiting of all phase winding terminals, upon detection of said unbalanced fault, with a separate switch connected to each of the terminals to produce a balanced fault condition so that DC current is precluded from circulating within the PMM.

These and other features, aspects and advantages of the present invention will become better understood with reference to the following drawings, description and claims.

### BRIEF DESCRIPTION OF THE DRAWINGS

FIG. 1 is a schematic diagram of power generating system in accordance with an embodiment of the invention;

FIG. 2 is a schematic diagram of a power generating system in accordance with a second embodiment of the invention; and

FIG. 3 is a flow chart of a method for fault remediation in a permanent magnet generator system in accordance with an embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention generally provides a generation system in which a wide speed range, high reactance permanent magnet machine (HRPMM) may provide actively rectified DC voltage over wide variations in the rotational speed of a prime mover. Remediation of unbalanced faults may be performed by short circuiting phase winding output terminals of the HRPMM through a plurality of solid state switches and thereby producing sustainable balanced fault conditions within the HRPMM. Advantageously the solid state switches may be incorporated into the system's bridge circuit. Because short circuiting current is distributed across multiple switches, the system may have a power capacity rating that is substantially greater than a power capacity rating of any one of the switches.

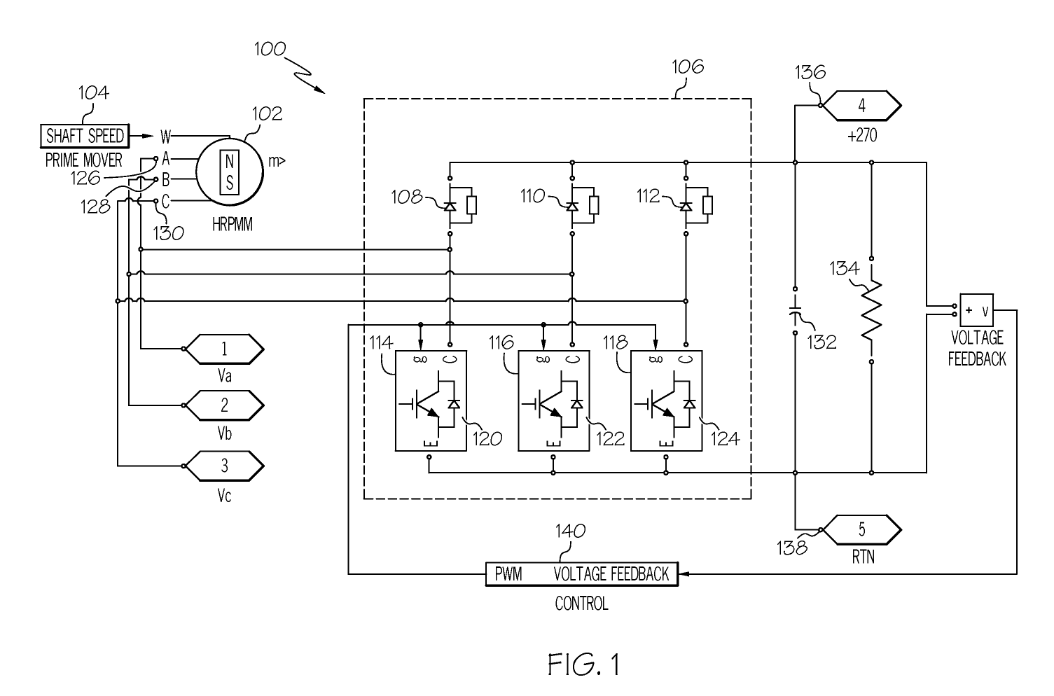

Turning now to the description and with reference first to FIG. 1, an exemplary embodiment of an electrical power generating system 100 may include a high reactance permanent magnet machine (HRPMM) 102 that may provide regulated voltage over wide variations in the rotational speed of a prime mover 104. The HRPMM 102 may be constructed and various aspects of its control may be performed in a manner consistent with a description that may be found in U.S. Pat. No. 7,595,612, issued on Sep. 29, 2009 and incorporated herein by reference.

The HRPMM 102 may be connected with a three phase AC voltage bridge circuit 106. Three diodes 108, 110 and 112, and three solid-state power switches 114, 116 and 118 may be arranged to form the bridge circuit 106. The power switches 114, 116 and 118 may have parallel diodes 120, 122 and 124 respectively. When the switches 114, 116 and 118 are OFF, the diodes 108, 110, 112, 120, 122 and 124 may rectify output voltages of phase winding output terminals 126, 128 and 130. When the switches 114, 116 and 118 are ON the phase winding output terminals 126, 128 and 130 of the HRPMM 102 may be shorted.

A capacitor 132 may be connected in parallel with the bridge circuit 106 to store energy and supply a load 134 with 270 Vdc. The capacitor 132 may also filter out voltage ripple due to the rectification and switching. The system 100 may use pulse-width modulation (PWM) to drive the switches 114, 116 and 118 to maintain the desired 270 Vdc at capacitor terminals 136 and 138. PWM frequency may be selected constant at about 20 KHz.

The generating system 100 has a capability of remediating unbalanced fault problems that may have occurred in prior-art permanent magnet generator based systems. An unbalanced fault condition may result in very high DC currents circulating in a permanent magnet generator. The system 100 may sustain balanced short-circuit current continuously. This ability of the system 100 to sustain balanced short-circuit condition may accommodate conversion of an unsymmetrical or unbalanced fault condition to a symmetrical or balanced short-circuit condition.

In operation, a control unit 140 may close or turn ON power switches 114, 116 and 118 upon detecting an unbalanced fault condition, the machine terminals 126, 128 and 130 may be short-circuited and, as a result, a balanced short circuit condition may be produced. This induced balanced fault condition removes circulating DC currents and allows a conventional protection system (not shown) to clear the fault while the HRPMM 102 sustains the balanced short-circuit currents. It may be seen that the system 100 may be constructed with an advantageous incorporation of both a rectification function and a fault remediation function in the bridge circuit 106.

The following tables summarize the effects of symmetrical and unsymmetrical faults that were generated using a simulation program. Peak value, average and sum of the phase currents (Iₐ, I_{b}, I_{c}) are shown in the tables for various conditions. In addition, results of DC and fundamental symmetrical components (Ipos, Ineg, Izero) are provided in the tables. When the faults are unsymmetrical, the average currents and the negative symmetrical components are nonzero, indicating the undesirable fault condition.

Table 1 shows results of a HRPMM generating system in normal operation. As expected, the averages of the phase currents and the negative symmetrical component are zero. Notice that the sum of the phase currents may always be zero regardless of the condition. This is expected if the HRPMM 102 is “Y” connected without a neutral fourth wire.

TABLE 1
Normal Operation

| | Peak AC | Peak DC | | |
|---|---|---|---|---|
| Parameter | Value (A) | Value (A) | Sum (A) | Average (A) |
| Iₐ | 700 | 0 | n/a | 0 |
| I_{b} | 700 | 0 | n/a | 0 |
| I_{c} | 700 | 0 | n/a | 0 |
| Iₐ, I_{b}, I_{c} | n/a | n/a | 0 | n/a |
| Iₚₒₛ | 700 | 0 | n/a | n/a |
| I_{neg} | 0 | 0 | n/a | n/a |
| I_{zero} | 0 | 0 | n/a | n/a |

As Table 2 shows, large DC current may develop when the diode 108 is shorted.

TABLE 2
Unsymmetrical Fault Due to Diode 108 Failing Short

| | Peak AC | Peak DC | | |
|---|---|---|---|---|
| Parameter | Value (A) | Value (A) | Sum (A) | Average (A) |
| Iₐ | 800 | 1085 | n/a | 1085 |
| I_{b} | 800 | −480 | n/a | −480 |
| I_{c} | 800 | −605 | n/a | −605 |
| Iₐ, I_{b}, I_{c} | n/a | n/a | 0 | n/a |
| Iₚₒₛ | 800 | 540 | n/a | n/a |
| I_{neg} | 0 | 540 | n/a | n/a |
| I_{zero} | 0 | 0 | n/a | n/a |

Table 3 shows the resulting currents when diodes 108 and 110 are shorted.

TABLE 3
Unsymmetrical Fault Due to Diodes 108 and 110 Failing Short

| | Peak AC | Peak DC | | |
|---|---|---|---|---|
| Parameter | Value (A) | Value (A) | Sum (A) | Average (A) |
| Iₐ | 800 | 290 | n/a | 290 |
| I_{b} | 800 | 260 | n/a | 260 |
| I_{c} | 800 | −550 | n/a | −550 |
| Iₐ, I_{b}, I_{c} | n/a | n/a | 0 | n/a |
| Iₚₒₛ | 800 | 275 | n/a | n/a |
| I_{neg} | 0 | 275 | n/a | n/a |
| I_{zero} | 0 | 0 | n/a | n/a |

With diodes 108 and 110 shorted, switches 114, 116 and 118 may be closed to create symmetrical fault. As shown in Table 4, the average phase current and the negative symmetrical component are zero indicating balanced condition. The current during this induced symmetrical fault is 800 A, only 100 A above full-load peak current shown in Table 1.

TABLE 4
Symmetrical Fault Due to Closing Switches
114, 116 and 118 to Clear Fault

| | Peak AC | Peak DC | | |
|---|---|---|---|---|
| Parameter | Value (A) | Value (A) | Sum (A) | Average (A) |
| Iₐ | 800 | 0 | n/a | 0 |
| I_{b} | 800 | 0 | n/a | 0 |
| I_{c} | 800 | 0 | n/a | 0 |
| Iₐ, I_{b}, I_{c} | n/a | n/a | 0 | n/a |
| Iₚₒₛ | 800 | 0 | n/a | n/a |
| I_{neg} | 0 | 0 | n/a | n/a |
| I_{zero} | 0 | 0 | n/a | n/a |

It may be noted that short circuiting of the machine terminal 126, 128 and 130 may involve switching high currents. The system 100 may utilize three switches to perform the switching task. In other words, the shorting current load is distributed through three switches. Thus, the overall power producing capability of the system 100 is not limited to the power rating of just one of the switches. By employing three switches to simultaneously perform shorting of the terminals 126, 128 and 130, the power producing capacity of the system 100 may be safely rated at approximately three times the power rating of any one of the switches 114, 116 or 118.

It may also be noted that the system 100 may be constructed to operate effectively in a high temperature environment such as an engine-embedded application. In that case the system 100 may be configured to employ silicon carbide devices as the switches 114, 116 and 118, and diodes 108, 110, and 112. While silicon carbide devices may have lower power delivery capability as compared to other conventional solid state switches, their high temperature tolerance may make their use uniquely beneficial for engine-embedded applications.

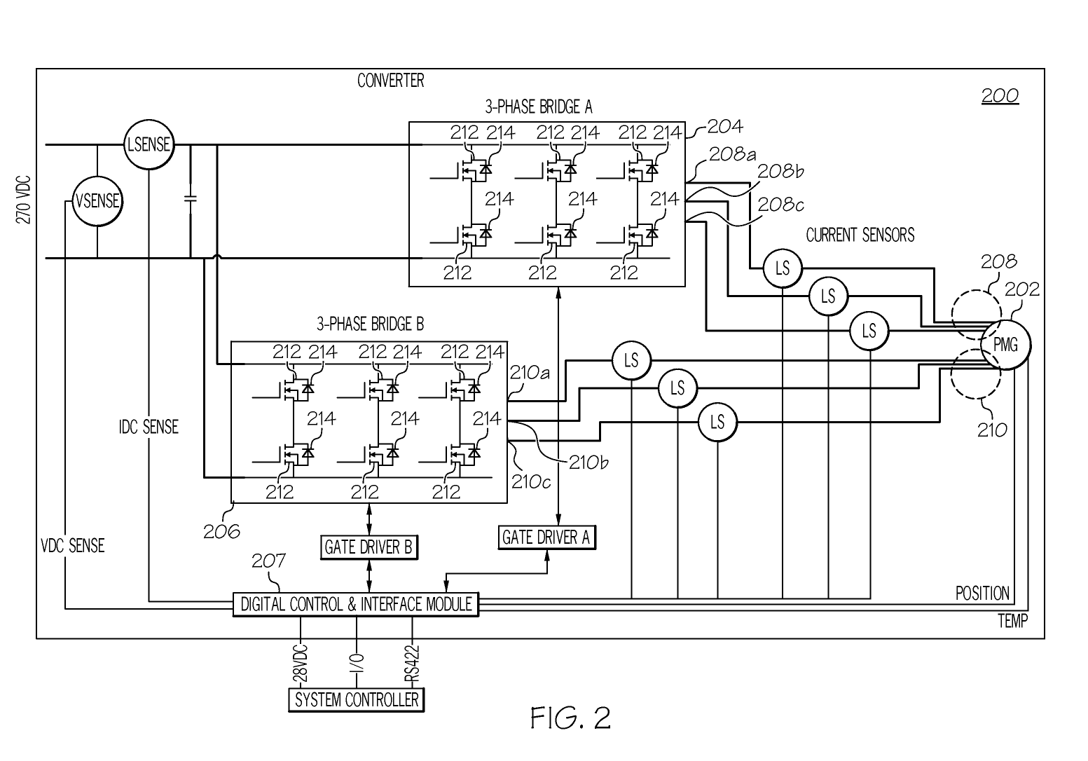

Referring now to FIG. 2, there is shown an exemplary embodiment of an HRPMM-based electrical generating system 200 in schematic format. The system 200 may include an HRPPM 202 interconnected with two bridge circuits 204 and 206. The bridge circuits may be coupled with and controlled by a control unit 207. As compared to the system 100 of FIG. 1, power capacity may further be increased by utilizing multiple sets of phase windings output terminals. For example, the HRPMM 202 may be provided with two sets, 208 and 210, of phase winding output terminals 208a, 208b, 208c and 210a, 210b and 210c. The output of each set of phase windings may be conditioned with a dedicated one of the bridge circuits 204 or 206 rated for half the total machine output power.

Each of the bridge circuits 204 and 206 may include six solid state switches 212. Each of the switches may include a parallel diode 214. As described above with respect to the system 100, rectification may be performed with the parallel diodes 214 and shorting of the sets of phase winding terminals 208 and 210 of the HRPPM 200 may be performed by simultaneously closing or turning ON one of the switches 212 for each of the phase winding output terminals. In the exemplary embodiment of the system 200 shown in FIG. 2, shorting current may be distributed through six of the switches 212. As a consequence, the system 200 can utilize high temperature components since the power rating of each one of the switches 212 may be reduced.

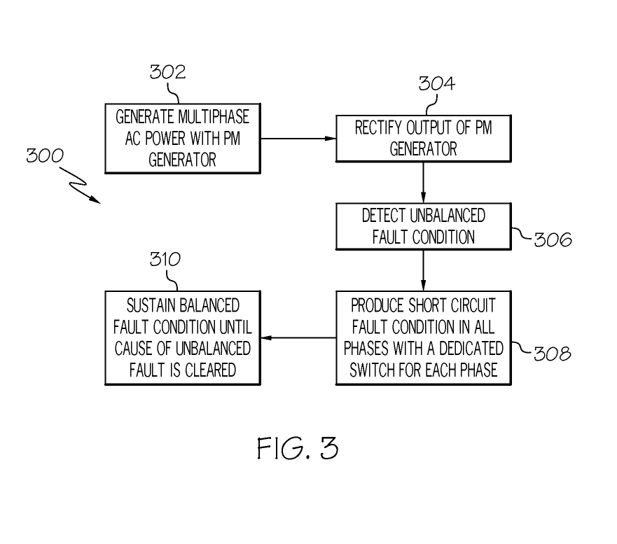

Referring now to FIG. 3, a flow chart illustrates an exemplary embodiment of a method 300 for fault remediation in a permanent magnet generator system. In a step 302, multiphase AC power may be produced with a permanent magnet machine (PMM) at a plurality of phase winding output terminals of the PMM (e.g., the HRPMM 100 or the HRPMM 200 may produce multiphase AC power). In a step 304, AC power produced by the HRPMM may be rectified (e.g., the bridge circuit 106 may employ the diodes 108, 110, 112, 120, 122 and 124 to perform rectification). In a step 306, an unbalanced fault may be detected in the system, (e.g., the control unit 140 may detect failure of the diode 108 and/or the diode 110 failing short). In a step 308, short circuiting of all phase winding terminals may be simultaneously produced with a separate switch connected to each of the terminals to produce a balanced fault condition, so that DC current is precluded from circulating within the HRPMM (e.g., the control unit 140 may command the switches 114, 116 and 118 to turn ON and produce shorting of the phase winding terminal 126, 128 and 130). In a step 310, the control unit 140 or 207 may sustain a balanced fault condition until a cause of the unbalanced fault is cleared.

It should be understood, of course, that the foregoing relates to exemplary embodiments of the invention and that modifications may be made without departing from the spirit and scope of the invention as set forth in the following claims.

1. A system for generating and supplying electrical power to DC loads on an aircraft comprising:
a permanent magnet machine (PMM) generating an output voltage at a plurality of output terminals;
a solid-state switch connected to each of the output terminals to short-circuit the output terminal when the switch is ON; and
a control unit configured to detect an unbalanced fault in the system and, responsively to said detection, to close all of the switches simultaneously to convert the unbalanced fault to a balanced fault so that DC currents are precluded from circulating within the PMM.

2. The system of claim 1 further comprising at least one bridge circuit wherein the short-circuiting switches are incorporated into the bridge circuit.

3. The system of claim 2 wherein the short-circuiting switches incorporated in the bridge circuit include parallel diodes.

4. The system of claim 1 further comprising a plurality of bridge circuits wherein the short-circuiting switches are incorporated into the bridge circuits.

5. The system of claim 4:
wherein the PMM is provided with multiple sets of phase winding output terminals;
wherein each of the sets of phase winding output terminals is coupled with a dedicated one of the bridge circuits; and
wherein, upon detection of one of the unbalanced faults, all of the phase windings output terminals are simultaneously shorted.

6. The system of claim 5:
wherein each set of the phase winding output terminals includes three phase winding output terminals;
wherein each of the bridge circuits includes six of the switches; and
wherein all of the switches include parallel diodes that perform rectification when the switches are OFF.

7. The system of claim 6 wherein three of the switches within each of the bridge circuits are connected to short one of the sets of phase winding terminals when the switches are ON.

8. The system of claim 1 wherein the switches are silicon carbide switches.

9. Apparatus for fault remediation in a permanent magnet generator system comprising at least one bridge circuit connected to a plurality of phase winding output terminals of a permanent magnet machine (PMM), the bridge circuit including a plurality of solid-state switches, each solid state switch connected to one of the phase winding output terminals, and actuatable to simultaneously short-circuit all of the output terminal upon detection of an unbalanced fault in the system so that the unbalanced fault is converted to a balanced fault and so that DC currents are precluded from circulating within the PMM.

10. The apparatus of claim 9 wherein the switches include parallel diodes and the diodes perform rectification when the switches are in an OFF state.

11. The apparatus of claim 9 further comprising a plurality of bridge circuits wherein the short-circuiting switches are incorporated into the bridge circuits.

12. The apparatus of claim 11:
wherein the PMM is provided with multiple sets of phase winding output terminals;
wherein each of the sets of phase winding output terminals is coupled with a dedicated one of the bridge circuits; and
wherein, upon detection of one of the unbalanced faults, all of the phase windings output terminals are simultaneously shorted.

13. The apparatus of claim 12,
wherein each set of the phase winding output terminals includes three phase winding output terminals;
wherein each of the bridge circuits includes six of the switches; and
wherein all of the switches include parallel diodes that perform rectification when the switches are OFF.

14. The system of claim 13 wherein three of the switches within each of the bridge circuits are connected to short one of the sets of phase winding output terminals when the switches are ON.

15. The system of claim 9 wherein the switches are silicon carbide switches.

16. A method for fault remediation in a permanent magnet generator system comprising the steps of:
producing multiphase AC power with permanent magnet machine (PMM) at a plurality of phase winding output terminals of the PMM;
detecting an unbalanced fault in the system; and
simultaneously short circuiting of all phase winding output terminals, upon said detection, with a separate switch connected to each of the terminals to produce a balanced fault condition so that DC current is precluded from circulating within the PMM.

17. The method of claim 16 further comprising the step of rectifying output voltage of the PMM with parallel diodes of the switches.

18. The method of claim 17:
wherein the step of rectifying is performed with at least two bridge circuits, each bridge circuit being dedicated to a set of phase winding terminals of the PMM; and
wherein the step of producing short circuiting is performed simultaneously by all of the bridge circuits.
